(19) United States
(12) Patent Application Publication
(10) Pub. No.: US 2011/0297762 A1
(43) Pub. Date: Dec. 8, 2011

(54) Burner Nozzle

(76) Inventor: Rickey E. WARK, Spring, TX (US)

(21) Appl. No.: 12/793,870

(22) Filed: Jun. 4, 2010

(51) Int. Cl. B05B 15/08

(52) U.S. Cl. 239/587.6

(57) ABSTRACT

A burner nozzle comprises a rectangular box-like ceramic tip and a stainless steel frame or jacket closely fit around the outer exterior of the tip. A journal structure is provided for pitch control purposes.

### FIELD OF THE INVENTION

This invention relates to burner nozzles for coal-fired boilers.

### BACKGROUND OF THE INVENTION

Coal-fired boilers typically use gun-like structures to emit streams of airborne particulate coal to serve as fuel for a controlled fireball. Such a structure is described in my 1993 U.S. Pat. No. 5,215,259 which shows a variable pitch nozzle mounted on a barrel. As described herein, I have invented an improvement to that nozzle.

### BRIEF SUMMARY OF THE INVENTION

Through the present invention, I have provided an improved nozzle structure for directing the flow of airborne particulate coal which withstands thermal cycling better than the structure described in the aforesaid '259 patent and which is straightforward to manufacture and install.

In general, the present invention comprises a burner nozzle including a tapered ceramic tip and a metal frame or jacket or frame wrapped around the ceramic tip. The ceramic tip can have splitter plates formed integrally therewith and the jacket or frame can be stainless steel.

In the illustrative embodiment hereinafter described, the nozzle tip and jacket are both four-sided structures but can be round or oval or polygonal as desired. The side panels of the metal jacket are provided with pivot bushing structures which allow the entire nozzle structure to be pivoted about a pitch axis for the purpose of aiming the airborne particulate coal stream.

As used herein, the term “ceramic” includes not only pure ceramics but also “cermets” such as aluminum oxide, tungsten carbide, silicon carbide and alloys of ceramics and cermets, all of which are castable and fireable so as to provide a hard, dimensionally stable and highly wear resistant structure.

### BRIEF SUMMARY OF THE DRAWINGS

The description herein makes reference to the accompanying drawings wherein like reference numerals refer to like parts throughout the several views and wherein:

FIG. 1 is a perspective view of the inventive nozzle pivotally mounted on an open-ended burner barrel;

FIG. 2 is an exploded view of the embodiment of FIG. 1;

FIG. 3 is a rear view of the ceramic nozzle showing portions of the stainless steel frame wrapping around the rear end surface thereof;

FIG. 4 is a side view of the burner nozzle showing in schematic form, the mechanism for varying the pitch angle of the nozzle; and

FIG. 5 is a sectional view through the bushing structure of the nozzle which permits variations of the pitch angle thereof.

### DETAILED DESCRIPTION OF THE ILLUSTRATIVE EMBODIMENT

Referring to the figures, there is shown a generally cylindrical tapered burner barrel 10 which is an open-ended structure of conventional design, usually lined with high hardness material for abrasion resistance material as it carries through it a highly abrasive load of airborne particulate coal. Mounted to the open end of the barrel 10 in a fashion which permits pitch variations is a burner nozzle 12 comprising the combination of a ceramic tip 14 and a close fitting and conforming outer stainless steel jacket or frame 38. It is to be understood that the invention can also be used with fixed pitch nozzles.

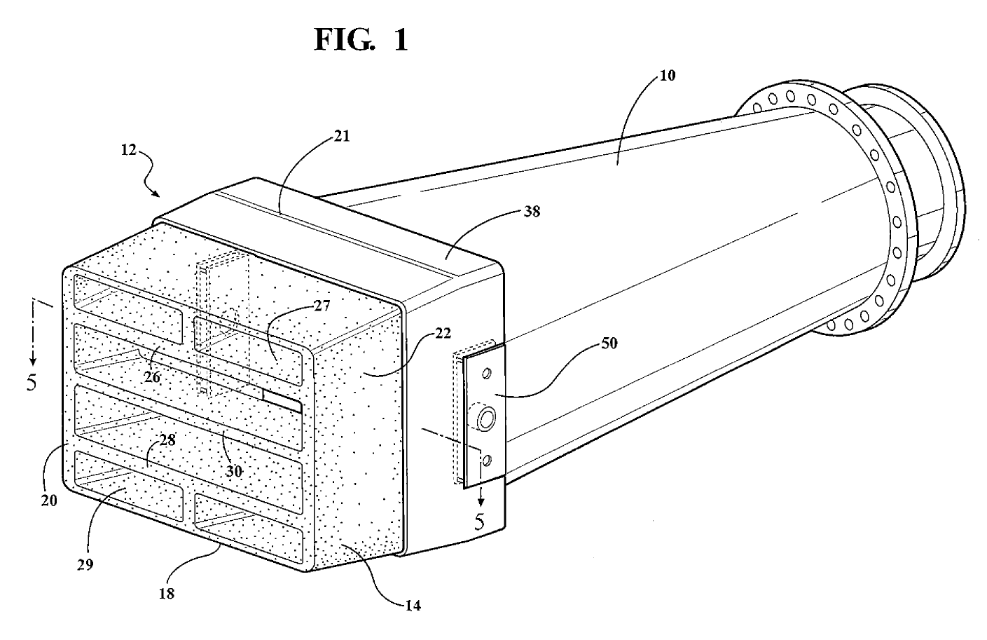

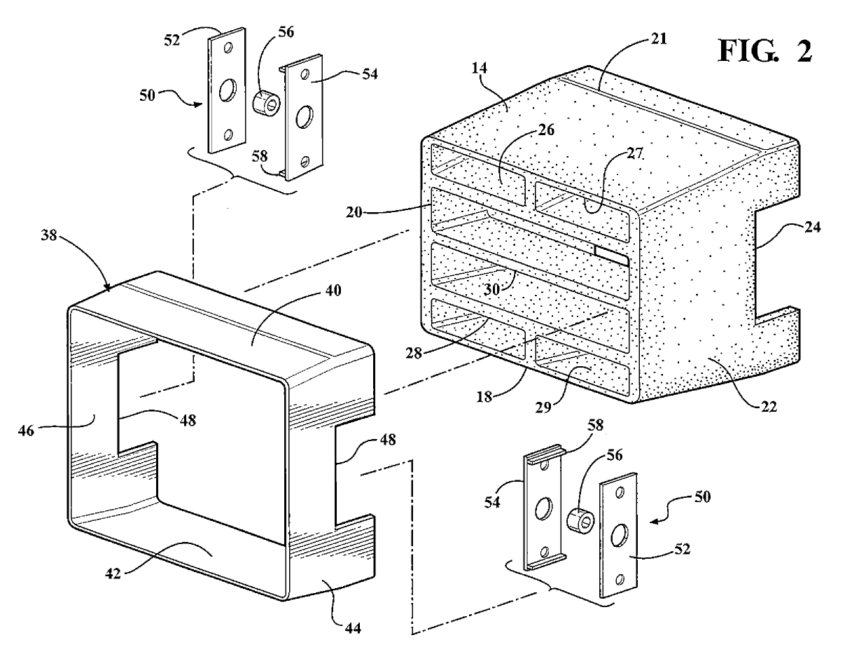

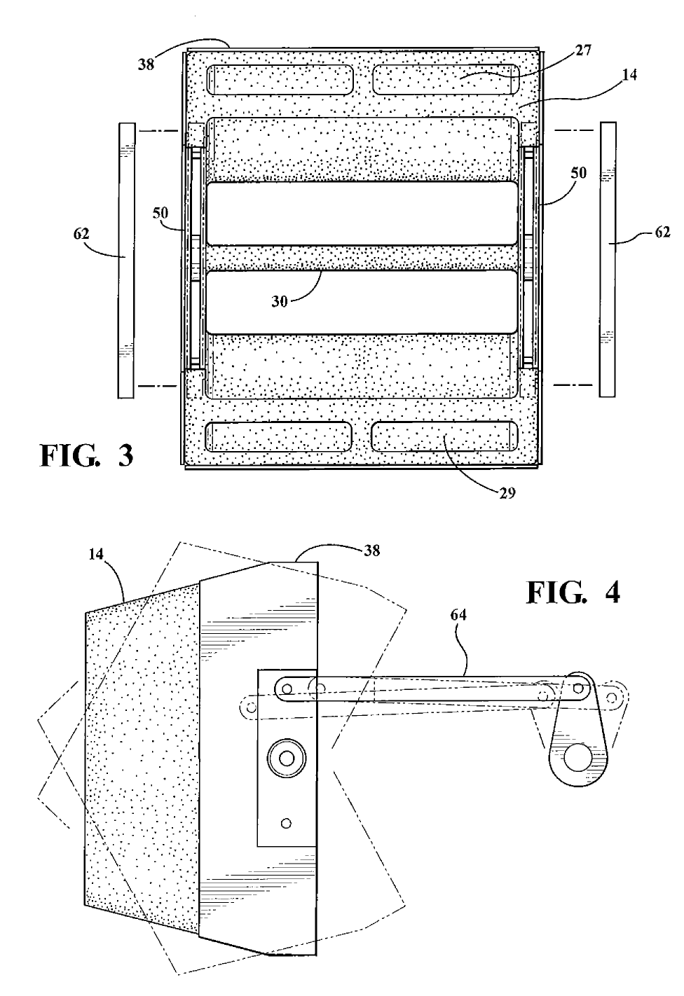

The ceramic tip 14 is generally rectangular in shape and has integral top 16, bottom 18, and sidewalls 20, 22, all of which are generally planar in nature although the top and bottom panels 16, 18 may have an angled break 21 toward the rear or right hand side, as shown in FIGS. 1 and 2. The side panels 20, 22 are relieved at 24 to receive a prefabricated journal assembly hereinafter described.

Overall, the rectangular nozzle tip 14 is tapered whereby the cross-sectional area of the front edge plane is smaller than the cross-sectional area of the rear edge plane. As mentioned above, the taper may end on the top and bottom panels 16, 18, respectively at a break point 21 near the larger rear edge plane.

The ceramic nozzle tip 14 is cast with integral horizontal panels 26, 28 to define secondary air paths 27, 29 respectively. In addition, a splitter plate 30 is formed integrally between the side panels to break up any solid streams of coal which may form.

Separately fabricated and installed upon the ceramic tip 14 is a stainless steel frame or jacket 38 having a top panel 40, a bottom panel 42 and side panels 44, 46. Both of the side panels are relieved or notched out at 48 in generally the same place and shape as the notches 24 in the tip 14 but about ¼ inch smaller along the three edges for purposes to be described.

The frame 38 is designed to conform to and fit in overlying relationship onto the ceramic tip 14; i.e., it's dimensions are such that an installer can slide the frame over the front edge plane of the tip 14 and push rearwardly until it rests snugly on and in conforming fit relationship to exterior surfaces of the tip 14 with the back edge of the frame 38 corresponding to the rear edge plane of the tip 14. In this arrangement the notches 48 substantially overlie the left and right cutouts 24 in the tip 14 but are smaller to create a ¼ inch overlap along all edges.

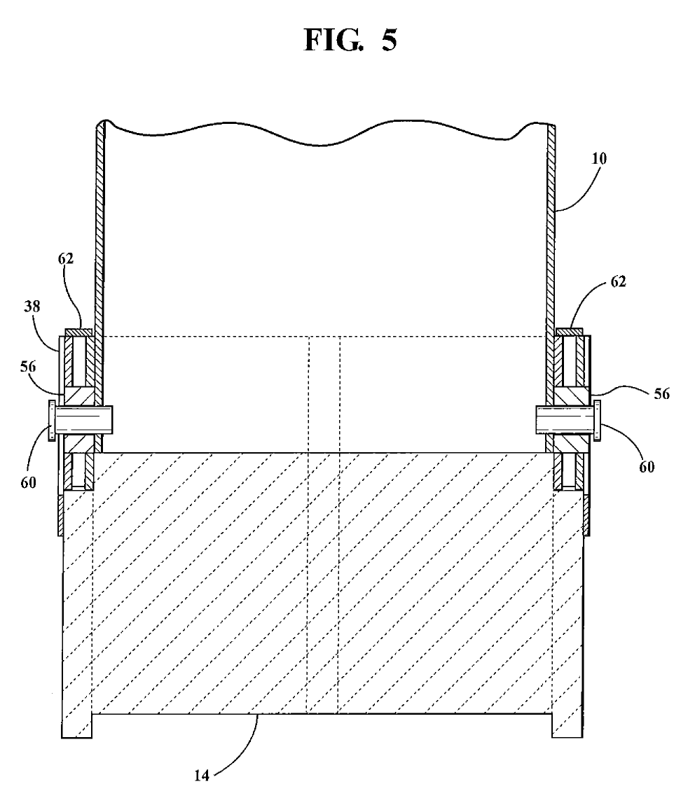

To provide a sturdy journal structure, two journal assemblies 50 are prefabricated by welding together plates 52, 54 and a bushing 56. Plates 54 have ribs 58 to create a separation between plates 52, 54. The sizes of plates 52, 54 is such that these prefabricated assemblies 50 can be wedged into notches 24 before the frame 38 is moved into place. They are then welded to the frame 38. The bushing 56 is formed from a solid steel rod 56 which is inserted through holes in the plates 52, 54, and welded in place and drilled through to form a journal which receives a pivot pin 60 when in the fully installed condition as best shown in FIG. 5. Keeper plates 62 can be welded to the outside edges of the journal structure plates 52 to firmly secure the journal structure. A mechanism 64 can be attached to the nozzle for pitch control purposes.

As indicated above, the nozzle tip 14 is cast of a suitable high hardness and wear-resistant ceramic material. The relief notches 24 may be cast into the original structure or created by saw cutting, preferably when the ceramic is in a pre-fired or “green” state. The jacket 38, preferably made of a stainless steel, is thereafter installed as described above. I have found this structure to be highly resistant to deterioration due to thermal cycling, as well as straightforward to fabricate, install, remove and replace.

What is claimed is:

1. A burner nozzle for directing a stream of airborne particulate coal comprising:
a ceramic tip having an outer surface and front and inner edge planes; and
a metal frame in overlying and conforming-fit relationship to said outer surface.

2. A burner nozzle described in claim 1 further comprising journal structures secured to the nozzle at opposite side locations to allow for pitch angle changes.

3. A burner nozzle as defined in claim 1 wherein the metal frame is stainless steel.

4. A burner nozzle as defined in claim 1 wherein the tip and frame are tapered.

5. An apparatus for directing a stream of airborne particulate coal toward a target area comprising:
an elongate burner barrel adapted to convey said stream of airborne particulate coal and having an open end;
a nozzle attached to the open end and including a ceramic tip; and
a steel frame secured to said tip in overlying external relationship.

6. An apparatus as defined in claim 5 wherein the metal of the frame is stainless steel.

7. An apparatus as defined in claim 5 wherein the tip and frame are rectangular.

8. An apparatus as defined in claim 6 wherein the tip and frame are tapered.
